(19) United States
(12) Patent Application Publication
(10) Pub. No.: US 2007/0177566 A1
(43) Pub. Date: Aug. 2, 2007

(54) Method and apparatus for coding of E-DCH dedicated physical control channel

(76) Inventors: Liang Xu, Shenzhen (CN); Xueging Zhu, Shenzhen (CN); Xinye Huang, Shenzhen (CN); Aijun Cao, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/645,894

(22) Filed: Dec. 27, 2006

Related U.S. Application Data
(63) Continuation of application No. PCT/CN05/01486, filed on Nov. 2, 2005.

(30) Foreign Application Priority Data
Sep. 20, 2004 (CN) 200410078034.9

(51) Int. Cl. H04B 7/216

(52) U.S. Cl. 370/342

(57) ABSTRACT

Embodiments of the present invention provide Method and apparatus for coding of an E-DCH Dedicated Physical Control Channel (E-DPCCH). The method includes encoding information bits of signalling on an E-DPCCH in a BLOCK coding manner. The apparatus includes a unit for encoding information bits of signalling on an E-DPCCH in a BLOCK coding manner. The embodiments of the present invention can solve the problem in which signalling overhead is high during signalling encoding, thus reduce transmission power of a terminal.

### FIELD OF THE INVENTION

The present invention relates to wireless communications, and more particularly, to a method and an apparatus for coding of an E-DPCCH (E-DCH (Enhanced Dedicated Channel) Dedicated Physical Control Channel).

### BACKGROUND OF THE INVENTION

Wideband Code Division Multiple Access (WCDMA) of which the system is being perfected represents one of the three main 3^{rd} Generation (3G) standards. In Release 5, WCDMA introduces a High Speed Downlink Packet Access (HSDPA) technique, which has been one of the most important characters of Release 5. The HSDPA technique, which enables the throughput of the WCDMA downlink to be two to three times the throughput provided by the prior releases, can be an effective bearer of various packet services, satisfying the demand for such multimedia service information as data, video, image and the like apart from voice anywhere at any moment.

Correspondingly, it is considered to introduce the standard of a High Speed Uplink Packet Access (HSUPA) technique into Release 6 of WCDMA. The core target of the HSUPA technique is to enable the throughput of a WCDMA uplink to increase by 50% to 70% than that provided by the prior releases to enhance the throughput of uplink packet data using several enhanced uplink techniques. HSUPA technique is an up-to-date technique, and the standard of HSUPA technique in Release 6 of a WCDMA system protocol is being shaped.

At present, while which coding manner will be adopted for an E-DPCCH of HSUPA technique has not been specified, the main technical solution is to adopt a Convolutional Coding (CC) manner. The CC in WCDMA defines two coding rates of which one is ½ and the other is ⅓, and the constraint length is 9; tail bits having 8 bits of value 0 often need to be added to the coding block to be encoded so as to assist the CC. Although the CC is a mature coding technique, adding 8-bit tail bits to the coding block will bring a considerable signalling overhead for an E-DPCCH due to fewer effective bits of signalling on an E-DPCCH.

### SUMMARY OF THE INVENTION

Embodiments of the present invention provide a method and an apparatus for coding of an E-DCH Dedicated Physical Control Channel (E-DPCCH), encoding an E-DPCCH with lower signalling coding overhead.

According to an embodiment, the method for coding of an E-DPCCH includes:

encoding information bits of signalling on an E-DPCCH in a BLOCK coding manner.

Said encoding the information bits of signalling includes:

encoding information bits of signalling on an E-DPCCH in the BLOCK coding manner if the number of the information bits of signalling on an E-DPCCH is not more than a threshold.

Said encoding information bits of signalling on an E-DPCCH in the BLOCK coding manner includes:

dividing the information bits of signalling on an E-DPCCH into at least one data block;

encoding the data block.

Said encoding the data block includes:

encoding the data block with a second-order Reed-Muller encoder.

Said encoding the data block with the second-order Reed-Muller encoder includes:

inputting the data block to be encoded into the second-order Reed-Muller encoder;

calculating output codeword bits according to the following formula:

$${b}_{i} = {\sum }_{n = 0}^{N - 1} ( {a}_{n} \times {M}_{i , n} ) mod 2 ;$$

wherein i is the sequence number of output codeword bits, N is the number of the data block to be encoded, n=0, 1, 2, 3 . . . N-1, aₙ is the n-th bit of the data block to be encoded, M_{i, n} is the i-th value of the n-th basic sequence, and bᵢ is the i-th bit of the output codeword bits.

Said encoding the data block with the second-order Reed-Muller encoder further includes:

selecting a part of the output codeword bits as codeword of the information bits.

According to another embodiment, the apparatus for coding of an E-DCH Dedicated Physical Control Channel (E-DPCCH) includes:

a unit for encoding information bits of signalling on an E-DPCCH in a BLOCK coding manner.

The unit includes:

a module for dividing the information bits of signalling on an E-DPCCH into at least one data block;

a module for encoding the data block in the BLOCK coding manner.

The module is a BLOCK encoder.

For example, the BLOCK encoder is a second-order Reed-Muller encoder.

The module includes a plurality of BLOCK encoders, used for encoding different numbers of the information bits.

For example, the BLOCK encoders are second-order Reed-Muller encoders.

Through analyzing the overhead of the information bits of signalling on an E-DPCCH in the CC manner, an embodiment of the present invention provides a BLOCK coding manner for the signalling on an E-DPCCH, that is, the information bits to be transferred is divided into at least one data block for encoding, thereby reducing signalling overhead and saving transmission power of a terminal.

### BRIEF DESCRIPTION OF THE DRAWINGS

FIG. 1 is a simplified diagram illustrating a channel coding process of information bits of signalling in accordance with an embodiment of the present invention.

FIG. 2 is a simplified schematic flowchart of a coding process in accordance with an embodiment of the present invention.

FIG. 3 is a simplified schematic flowchart of a coding process in accordance with another embodiment of the present invention.

### DETAILED DESCRIPTION OF THE INVENTION

The present invention is hereinafter further described in detail with reference to the accompanying drawings and preferred embodiments to further clarify the technical solutions and advantages of the present invention.

Though almost all coding techniques conventionally used are maturely, a CC technique, as a coding technique with simple implementation and high encoding performance, is adopted widely in the art. However, tail bits having 8 bits of value 0 often need to be added to the coding block before being encoded so as to assist the CC during the coding procedure thereof adopted in a WCDMA system, which has little impact on the case that the information bits to be encoded are relatively more but brings obvious waste of power (about 2.6 dB) in the case that information bits are fewer, especially in the case of signalling coding. An embodiment of the present invention provides a BLOCK coding in view of the characteristic that information bits of signalling are fewer on an E-DPCCH.

Descriptions are given hereinafter with an example of the coding process of an E-DPCCH in a WCDMA system.

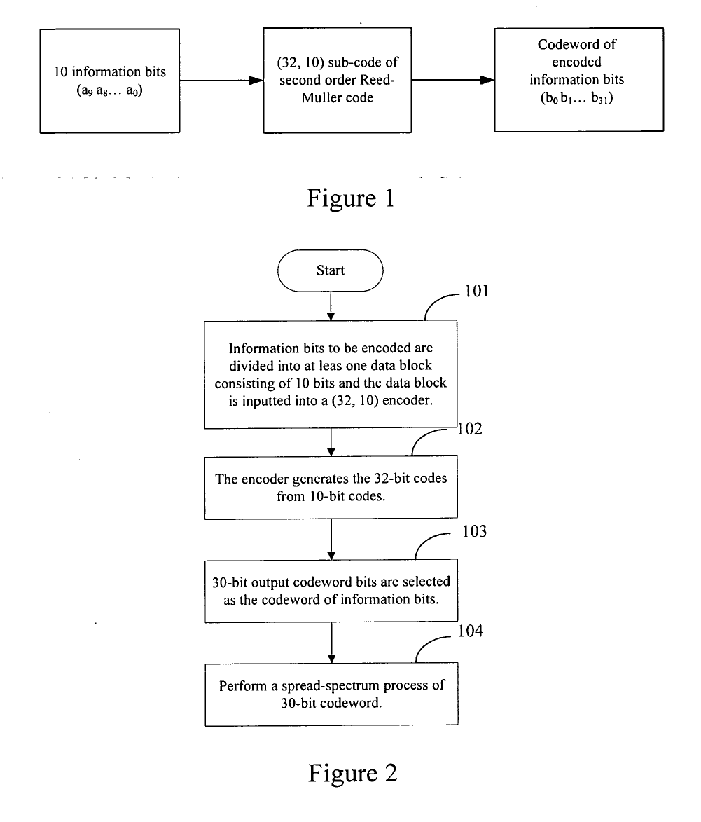

An embodiment of the present invention describes the coding process, for example in the case that the number of information bits of signalling is 10. As shown in FIG. 1, a BLOCK coding is performed with a (32, 10) second-order Reed-Muller encoder which may generate 32-bit output codes after encoding if 10 bits are inputted. The encoder has, for example, the combinations of 10 basic sequences which are listed in Table 1. As shown in Table 2, for example, the basic sequences M_{i, 0}, M_{i, 1}, M_{i, 2}, M_{i, 3}, M_{i, 4}, M_{i, 5}, M_{i, 6}, M_{i, 7}, M_{i, 8} and M_{i, 9} (i=0, 1, 2, . . . , 31).

TABLE 1

| i | M_{i,0} | M_{i,1} | M_{i,2} | M_{i,3} | M_{i,4} | M_{i,5} | M_{i,6} | M_{i,7} | M_{i,8} | M_{i,9} |
|---|---|---|---|---|---|---|---|---|---|---|
| 0 | 1 | 0 | 0 | 0 | 0 | 1 | 0 | 0 | 0 | 0 |
| 1 | 0 | 1 | 0 | 0 | 0 | 1 | 1 | 0 | 0 | 0 |
| 2 | 1 | 1 | 0 | 0 | 0 | 1 | 0 | 0 | 0 | 1 |
| 3 | 0 | 0 | 1 | 0 | 0 | 1 | 1 | 0 | 1 | 1 |
| 4 | 1 | 0 | 1 | 0 | 0 | 1 | 0 | 0 | 0 | 1 |
| 5 | 0 | 1 | 1 | 0 | 0 | 1 | 0 | 0 | 1 | 0 |
| 6 | 1 | 1 | 1 | 0 | 0 | 1 | 0 | 1 | 0 | 0 |
| 7 | 0 | 0 | 0 | 1 | 0 | 1 | 0 | 1 | 1 | 0 |
| 8 | 1 | 0 | 0 | 1 | 0 | 1 | 1 | 1 | 1 | 0 |
| 9 | 0 | 1 | 0 | 1 | 0 | 1 | 1 | 0 | 1 | 1 |
| 10 | 1 | 1 | 0 | 1 | 0 | 1 | 0 | 0 | 1 | 1 |
| 11 | 0 | 0 | 1 | 1 | 0 | 1 | 0 | 1 | 1 | 0 |
| 12 | 1 | 0 | 1 | 1 | 0 | 1 | 0 | 1 | 0 | 1 |
| 13 | 0 | 1 | 1 | 1 | 0 | 1 | 1 | 0 | 0 | 1 |
| 14 | 1 | 1 | 1 | 1 | 0 | 1 | 1 | 1 | 1 | 1 |
| 15 | 1 | 0 | 0 | 0 | 1 | 1 | 1 | 1 | 0 | 0 |
| 16 | 0 | 1 | 0 | 0 | 1 | 1 | 1 | 1 | 0 | 1 |
| 17 | 1 | 1 | 0 | 0 | 1 | 1 | 1 | 0 | 1 | 0 |
| 18 | 0 | 0 | 1 | 0 | 1 | 1 | 0 | 1 | 1 | 1 |
| 19 | 1 | 0 | 1 | 0 | 1 | 1 | 0 | 1 | 0 | 1 |
| 20 | 0 | 1 | 1 | 0 | 1 | 1 | 0 | 0 | 1 | 1 |
| 21 | 1 | 1 | 1 | 0 | 1 | 1 | 0 | 1 | 1 | 1 |
| 22 | 0 | 0 | 0 | 1 | 1 | 1 | 0 | 1 | 0 | 0 |
| 23 | 1 | 0 | 0 | 1 | 1 | 1 | 1 | 1 | 0 | 1 |
| 24 | 0 | 1 | 0 | 1 | 1 | 1 | 1 | 0 | 1 | 0 |
| 25 | 1 | 1 | 0 | 1 | 1 | 1 | 1 | 0 | 0 | 1 |
| 26 | 0 | 0 | 1 | 1 | 1 | 1 | 0 | 0 | 1 | 0 |
| 27 | 1 | 0 | 1 | 1 | 1 | 1 | 1 | 1 | 0 | 0 |
| 28 | 0 | 1 | 1 | 1 | 1 | 1 | 1 | 1 | 1 | 0 |
| 29 | 1 | 1 | 1 | 1 | 1 | 1 | 1 | 1 | 1 | 1 |
| 30 | 0 | 0 | 0 | 0 | 0 | 1 | 0 | 0 | 0 | 0 |
| 31 | 0 | 0 | 0 | 0 | 1 | 1 | 1 | 0 | 0 | 0 |

Referring to FIG. 2, a specific BLOCK coding process of the embodiment is as follows.

Step 101: information bits to be encoded are divided into at least one data block, each data block consists of 10 bits and is inputted into the (32, 10) encoder.

10-bit information bits are, for example, considered as a data block, and the data block is inputted into the encoder in turn as a0, a1, a2, a3, a4, a5, a6, a7, a8 and a9 (corresponding to information bits index which is expressed in unsigned binary form), respectively.

Step 102: the encoder generates 32-bit codes from 10-bit codes.

The output codeword bits corresponding to the information bits index are, for example, given by:

$${b}_{i} = {\sum }_{n = 0}^{9} ( {a}_{n} \times {M}_{i , n} ) mod 2 ;$$

where i is the sequence number of the output codeword bits, M_{i, n} is the i-th value of the n-th basic sequence shown in Table 1, and bᵢ (i=0, 1, 2, . . . , 31) denote the output codeword bits.

Step 103: bᵢ (i=0, 1, 2, . . . , 29) are selected as 30-bit codeword of the information bits.

Step 104: perform a spread-spectrum process of the 30-bit codeword.

For example, three slots, namely 2 ms slots are obtained by using an S=256 spread-spectrum device, and sent on an E-DPCCH.

The above is the coding process in the case that the number of the information bits of signalling is 10. For different numbers of information bits of signalling on an E-DPCCH, different coding processes can be implemented by selecting different encoders according to the number of the information bits. For example, in the case that the number of the information bits is 12, a (32, 12) second-order Reed-Muller encoder which may generate 32-bit output codes upon encoding if 12 bits are inputted is needed, that is, a new combination of basic sequences, namely 12 basic sequences shown as Table 2, needs to be constructed. As shown in Table 3, for example, the basic sequences consist of M_{i, 0}, M_{i, 1}, M_{i, 2}, M_{i, 3}, M_{i, 4}, M_{i, 5}, M_{i, 6}, M_{i, 7}, M_{i, 8}, M_{i, 9}, M_{i, 10} and M_{i, 11} (i=0, 1, 2, . . . , 31).

TABLE 2

| i | M_{i,0} | M_{i,1} | M_{i,2} | M_{i,3} | M_{i,4} | M_{i,5} | M_{i,6} | M_{i,7} | M_{i,8} | M_{i,9} | M_{i,10} | M_{i,11} |
|---|---|---|---|---|---|---|---|---|---|---|---|---|
| 0 | 1 | 1 | 1 | 1 | 1 | 1 | 0 | 0 | 0 | 0 | 0 | 0 |
| 1 | 1 | 1 | 1 | 1 | 1 | 0 | 0 | 0 | 0 | 1 | 0 | 0 |
| 2 | 1 | 1 | 1 | 1 | 0 | 1 | 0 | 0 | 1 | 0 | 0 | 1 |
| 3 | 1 | 1 | 1 | 1 | 0 | 0 | 0 | 0 | 1 | 1 | 0 | 1 |
| 4 | 1 | 1 | 1 | 0 | 1 | 1 | 0 | 1 | 0 | 0 | 1 | 0 |
| 5 | 1 | 1 | 1 | 0 | 1 | 0 | 0 | 1 | 0 | 1 | 1 | 0 |
| 6 | 1 | 1 | 1 | 0 | 0 | 1 | 0 | 1 | 1 | 0 | 1 | 1 |
| 7 | 1 | 1 | 1 | 0 | 0 | 0 | 0 | 1 | 1 | 1 | 1 | 1 |
| 8 | 1 | 1 | 0 | 1 | 1 | 1 | 1 | 0 | 0 | 0 | 1 | 1 |
| 9 | 1 | 1 | 0 | 1 | 1 | 0 | 1 | 0 | 0 | 1 | 1 | 1 |
| 10 | 1 | 1 | 0 | 1 | 0 | 1 | 1 | 0 | 1 | 0 | 1 | 0 |
| 11 | 1 | 1 | 0 | 1 | 0 | 0 | 1 | 0 | 1 | 1 | 1 | 0 |
| 12 | 1 | 1 | 0 | 0 | 1 | 1 | 1 | 1 | 0 | 0 | 0 | 1 |
| 13 | 1 | 1 | 0 | 0 | 1 | 0 | 1 | 1 | 0 | 1 | 0 | 1 |
| 14 | 1 | 1 | 0 | 0 | 0 | 1 | 1 | 1 | 1 | 0 | 0 | 0 |
| 15 | 1 | 1 | 0 | 0 | 0 | 0 | 1 | 1 | 1 | 1 | 0 | 0 |
| 16 | 1 | 0 | 1 | 1 | 1 | 1 | 1 | 1 | 1 | 1 | 0 | 0 |
| 17 | 1 | 0 | 1 | 1 | 1 | 0 | 1 | 1 | 1 | 0 | 0 | 0 |
| 18 | 1 | 0 | 1 | 1 | 0 | 1 | 1 | 1 | 0 | 1 | 0 | 1 |
| 19 | 1 | 0 | 1 | 1 | 0 | 0 | 1 | 1 | 0 | 0 | 0 | 1 |
| 20 | 1 | 0 | 1 | 0 | 1 | 1 | 1 | 0 | 1 | 1 | 1 | 0 |
| 21 | 1 | 0 | 1 | 0 | 1 | 0 | 1 | 0 | 1 | 0 | 1 | 0 |
| 22 | 1 | 0 | 1 | 0 | 0 | 1 | 1 | 0 | 0 | 1 | 1 | 1 |
| 23 | 1 | 0 | 1 | 0 | 0 | 0 | 1 | 0 | 0 | 0 | 1 | 1 |
| 24 | 1 | 0 | 0 | 1 | 1 | 1 | 0 | 1 | 1 | 1 | 1 | 1 |
| 25 | 1 | 0 | 0 | 1 | 1 | 0 | 0 | 1 | 1 | 0 | 1 | 1 |
| 26 | 1 | 0 | 0 | 1 | 0 | 1 | 0 | 1 | 0 | 1 | 1 | 0 |
| 27 | 1 | 0 | 0 | 1 | 0 | 0 | 0 | 1 | 0 | 0 | 1 | 0 |
| 28 | 1 | 0 | 0 | 0 | 1 | 1 | 0 | 0 | 1 | 1 | 0 | 1 |
| 29 | 1 | 0 | 0 | 0 | 1 | 0 | 0 | 0 | 1 | 0 | 0 | 1 |
| 30 | 1 | 0 | 0 | 0 | 0 | 1 | 0 | 0 | 0 | 1 | 0 | 0 |
| 31 | 1 | 0 | 0 | 0 | 0 | 0 | 0 | 0 | 0 | 0 | 0 | 0 |

Another embodiment of the present invention provides different coding process of encoding different numbers of information bits.

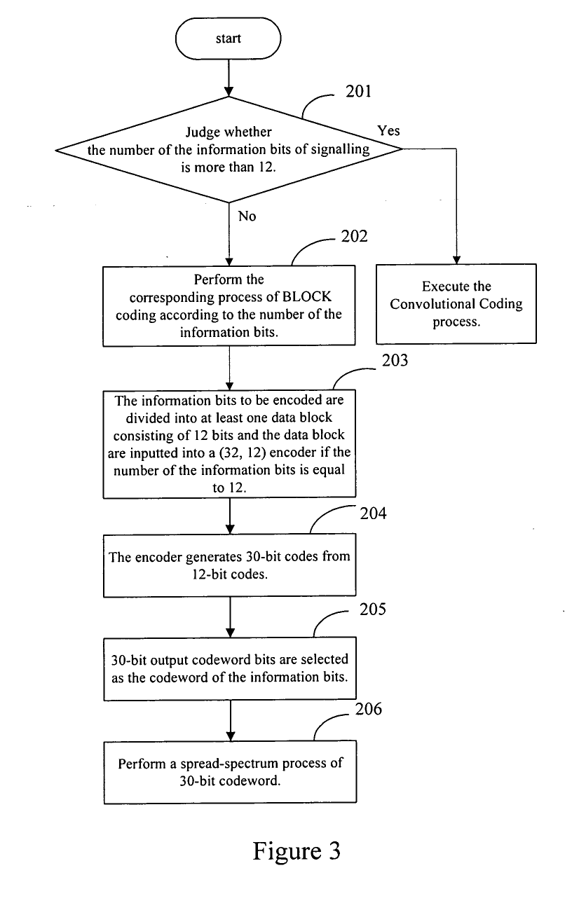

Referring to FIG. 3, a specific BLOCK coding process of the embodiment is as follows.

Step 201: judge whether the number of the information bits of signalling is more than 12; if yes, execute the process of CC; otherwise, proceed to Step 202.

Step 202: perform the corresponding process of BLOCK encoding according to the number of the information bits.

For example, if the number of the information bits is equal to 12; proceed to Step 203.

For example, if the number of the information bits is less than 10, it is padded with zeros to 10 bits by setting the most significant bits to zero, and then execute the coding process of encoding 10-bit information bits.

For example, if the number of information bits is 10, execute the coding process of encoding 10-bit information bits.

Because the number of the information bits of signalling on an E-DPCCH is 10 or 12, herein take the coding process in the case that the numbers of the information bits are 10 and 12 as an example to describe an embodiment of the present invention, and the coding process of other numbers of information bits may be analogical.

Step 203: the information bits to be encoded are divided into at least one data block, each data block consists 12 bits and is inputted into a (32, 12) encoder.

12-bit information bits are, for example, considered as a data block and the data block is inputted into the encoder in turn as a0, a1, a2, a3, a4, a5, a6, a7, a8, a9, a10 and a11 (corresponding to information bits index which is expressed in unsigned binary form), respectively.

Step 204: the encoder generates 32-bit codes from 12-bit codes.

The output codeword bits corresponding to the information bits index are, for example, given by:

$${b}_{i} = {\sum }_{n = 0}^{11} ( {a}_{n} \times {M}_{i , n} ) mod 2 ;$$

where i is the sequence number of the output codeword bits, M_{i, n} is the i-th value of the n-th basic sequence shown in Table 2, and bᵢ (i=0, 1, 2, . . . , 31) denote the output codeword bits.

Step 205: bᵢ (i=0, 1, 2, . . . , 29) are selected as 30-bit codeword of the information bits.

Step 206: perform a spread-spectrum process of the 30-bit codeword.

For example, three slots, namely 2 ms slots are, obtained by using an S=256 spread-spectrum device, and sent on an E-DPCCH.

Other encoders which may implement BLOCK coding also may be adopted. The BLOCK coding disclosed by an embodiment of the present invention is suitable for the situation that the overhead of CC exceeds a threshold. If the overhead of the tail bits in CC, for example, occupies more than 30% of all overhead, the BLOCK coding manner according to an embodiment of the present invention may be adopted for encoding. For example, on an E-DPCCH, NodeB scheduling information consists of at most 10 effective bits and a Hybrid Automatic Repeat Request (HARQ) consists of at most 12 effective bits. As shown in Table 3, in the CC manner, the numbers of signalling overhead of the tail bits of the NodeB scheduling information and HARQ information are 44% and 40%, respectively. While, in the BLOCK manner, for example, if the number of the information bits is less than 10, it is padded with zeros to 10 bits by setting the most significant bits to zero; if the number of the information bits is 8, the numbers of signalling overhead is more than 20%; if the number of the information bits are not less than 10, the number of signalling overhead is zero. It can be seen that signalling overhead may be reduced to zero or avoided in accordance with an embodiment of the present invention.

The foregoing description is only preferred embodiments of the present invention and is not for use in limiting the protection scope thereof. All the modifications, equivalent replacements or improvements in the scope of the present invention's spirit and principles shall be included in the protection scope of the present invention.

TABLE 3

| | Number of | Number of | Signalling |
|---|---|---|---|
| Signalling contents | information bits | tail bits | overhead |
| NodeB scheduling | 10 | 8 | 44% |
| information | | | |
| HARQ information | 12 | 8 | 40% |

1. A method for coding of an E-DCH Dedicated Physical Control Channel (E-DPCCH), comprising:
encoding information bits of signalling on an E-DPCCH in a BLOCK coding manner.

2. The method of claim 1, wherein said encoding the information bits of signalling comprises:
encoding information bits of signalling on an E-DPCCH in the BLOCK coding manner if the number of the information bits of signalling on an E-DPCCH is not more than a threshold.

3. The method of claim 2, wherein the threshold is 12.

4. The method of claim 1, wherein said encoding information bits of signalling on an E-DPCCH in the BLOCK coding manner comprises:
dividing the information bits of signalling on an E-DPCCH into at least one data block;
encoding the data block.

5. The method of claim 4, wherein the number of the information bits of signalling on an E-DPCCH is 10, and the number of the information bits of the data block is 10.

6. The method of claim 4, wherein the number of the information bits of signalling on an E-DPCCH is 12, and the number of the information bits of the data block is 12.

7. The method of claims 4, wherein said encoding the data block comprises:
encoding the data block with a second-order Reed-Muller encoder.

8. The method of claim 7, wherein said encoding the data block with the second-order Reed-Muller encoder comprises:
inputting the data block to be encoded into the second-order Reed-Muller encoder;
calculating output codeword bits according to the following formula:
$${b}_{i} = {\sum }_{n = 0}^{N - 1} ( {a}_{n} \times {M}_{i , n} ) mod 2 ;$$
wherein i is the sequence number of the output codeword bits, N is the bit number of the data block to be encoded, n=0, 1, 2, 3 . . . N-1, aₙ is the n-th bit of the data block to be encoded, M_{i, n} is the i-th value of the n-th basic sequence, and bᵢ is the i-th bit of the output codeword bits.

9. The method of claim 8, wherein said encoding the data block with the second-order Reed-Muller encoder further comprises:
selecting a part of the output codeword bits as codeword of the information bits.

10. The method of claim 9, wherein the number of the output codeword bits is 32, and said selecting a part of the output codeword bits comprises:
selecting 30 bits from 32 output codeword bits as the codeword of the information bits.

11. An apparatus for coding of an E-DCH Dedicated Physical Control Channel (E-DPCCH), comprising:
a unit for encoding information bits of signalling on an E-DPCCH in a BLOCK coding manner.

12. The apparatus of claim 11, wherein the unit comprises:
a module for dividing the information bits of signalling on an E-DPCCH into at least one data block;
a module for encoding the data block in the BLOCK coding manner.

13. The apparatus of claim 12, wherein the module is a BLOCK encoder.

14. The apparatus of claim 13, wherein the BLOCK encoder is a second-order Reed-Muller encoder.

15. The apparatus of claim 12, wherein the module comprises a plurality of BLOCK encoders, used for encoding different numbers of the information bits.

16. The apparatus of claim 15, wherein the BLOCK encoders are second-order Reed-Muller encoders.
